(19) United States
(12) Patent Application Publication
(10) Pub. No.: US 2023/0330730 A1
(43) Pub. Date: Oct. 19, 2023

(54) SPECIAL INTERNAL-COOLING ROLLING TOOL CAPABLE OF REALIZING VARIABLE-ANGLE LOW-TEMPERATURE LUBRICATION

(71) Applicant: BEIJING INSTITUTE OF TECHNOLOGY, Beijing (CN)

(72) Inventors: Pei YAN, Beijing (CN); Jie SUN, Beijing (CN); Lei FAN, Beijing (CN); Xibin WANG, Beijing (CN); Li JIAO, Beijing (CN); Tianyang QIU, Beijing (CN); Wenxiang ZHAO, Beijing (CN); Tianfeng ZHOU, Beijing (CN); Zhibing LIU, Beijing (CN); Lijing XIE, Beijing (CN); Bin ZHAO, Beijing (CN); Zhiqiang LIANG, Beijing (CN); Longlong TENG, Beijing (CN); Wenhua SHEN, Beijing (CN)

(21) Appl. No.: 18/139,377

(22) Filed: Apr. 26, 2023

Related U.S. Application Data
(63) Continuation of application No. PCT/CN2021/125009, filed on Oct. 20, 2021.

(30) Foreign Application Priority Data
Mar. 23, 2021 (CN) 202110307184.6

(51) Int. Cl. B21B 45/02

(52) U.S. Cl. CPC B21B 45/0248; B21B 45/0209

(57) ABSTRACT

An internal-cooling rolling tool capable of realizing variable-angle low-temperature lubrication is provided. The internal-cooling rolling tool includes a tool handle, a rotatable tool head and a medium conveying tube. The rotatable tool head includes a base, a rolling head and a ball. The bottom end of the base is mounted on the tool handle, and the top of the base is provided with a medium input port connected with the medium conveying tube. The rolling head is detachably mounted on the front end surface of the base, and the front end surface of base is provided with a plurality of spray holes in the circumferential direction of the rolling head. The medium conveying tube communicates with the spray holes through a medium flow channel. The ball is mounted on one end of the rolling head facing away from the base.

### FIELD

The present disclosure relates to the technical field of metal rolling, and in particular to a special internal-cooling rolling tool capable of realizing variable-angle low-temperature lubrication.

### BACKGROUND

Rolling is a plastic processing method that does not involve cutting. A rolling tool is used to apply a certain pressure to the surface of a workpiece to enable metal on the surface of the workpiece to generate plastic flow, so that the material at the crest fills the trough, which makes the surface roughness of the workpiece lower. At the same time, since plastic deformation occurs to the rolled metal on the surface, the surface structure undergoes cold-work hardening, thus forming dense fibers and a residual stress layer, so the hardness and strength are increased, which thereby improves the fatigue resistance. However, the rolling strengthening alone can introduce little compressive residual stress to the surface of the material, and higher surface quality can be obtained by combining the rolling strengthening technique with other surface modification techniques.

Low-temperature rolling on metal surface is to keep the metal on the surface in a low-temperature state in a rolling strengthening process. After the strengthening process is completed, since the metal inside and the metal on the surface are expanded to different degrees during the restoration to room temperature, compressive residual stress is introduced into the metal on the surface, which can make up for the insufficient rolling strengthening effect. Minimum quantity lubrication is a technique that performs cooling and lubrication on a to-be-processed region with oil mist particles obtained by atomizing a small amount of lubricant oil by compressed air. This technique can improve processing conditions and reduce friction and wear, and has been widely used in recent years. There is provided a low-temperature rolling device in the prior art, which realizes low-temperature rolling by using an external cooling system that continuously cools the workpiece in the process of rolling the workpiece. However, the position of the nozzle needs to be adjusted manually, which leads to the problems of low working efficiency and low precision.

### SUMMARY

In view of this, the present disclosure provides a special internal-cooling rolling tool capable of realizing variable-angle low-temperature lubrication, which can realize low-temperature rolling of the surface of a metal material and is simple to operate and convenient to install. The internal-cooling rolling tool simplifies the structure of the rolling device, and solves the problems of low working efficiency and low precision in the existing low-temperature rolling device.

The present disclosure adopts the following specific technical solution:

Provided is a special internal-cooling rolling tool capable of realizing variable-angle low-temperature lubrication, including a tool handle, a rotatable tool head and a medium conveying tube.

The tool handle is provided with a front end for assembling the rotatable tool head and a rear end for being fixedly mounted on a tool holder.

The rotatable tool head includes a base, a rolling head and a ball. The bottom end of the base is mounted on the tool handle, the top of the base is provided with a medium input port connected with the medium conveying tube, and a medium flow channel is disposed inside the base. The rolling head is detachably mounted on the front end surface of the base, and the front end surface of the base is provided with a plurality of spray holes for spraying a cooling and lubricating medium in the circumferential direction of the rolling head. The ball is mounted on one end of the rolling head facing away from the base.

The medium conveying tube communicates with the spray holes through the medium flow channel. The medium conveying tube is used to convey the cooling and lubricating medium.

The base has a rotating state and a locked state and is capable of switching between the rotating state and the locked state.

When the base is in the rotating state, the base is capable of rotating in a horizontal plane relative to the tool handle so as to realize adjustment of the rolling head.

When the base is in the locked state, the base is fixed relative to the tool handle so as to perform rolling.

Further, the medium flow channel is provided with an internal annular flow channel communicating with all the spray holes.

Further, the base is provided with a plurality of locking holes distributed in the circumferential direction.

The tool handle is provided with one locating pillar protruding toward the base.

When the base is in the rotating state, the locating pillar is disengaged from the locking hole.

When the base is in the locked state, the locating pillar is inserted into one of the locking holes, and the locating pillar is used to limit the rotation of the base in the horizontal plane.

Further, the tool handle is provided with a plurality of locking holes distributed in the circumferential direction.

The base is provided with one locating pillar protruding toward the tool handle.

When the base is in the rotating state, the locating pillar is disengaged from the locking hole.

When the base is in the locked state, the locating pillar is inserted into one of the locking holes, and the locating pillar is used to limit the rotation of the base in the horizontal plane.

Further, the bottom end of the base is provided with a central hole.

The tool handle is provided with a central shaft corresponding to the central hole in position.

The central shaft and the central hole are in clearance fit.

Further, the bottom end of the base is provided with a central shaft protruding toward the tool handle.

The tool handle is provided with a central hole corresponding to the central shaft in position.

The central shaft and the central hole are in clearance fit.

Further, the ball is a diamond ball or a ceramic ball.

Further, the medium conveying tube is threadedly connected to the base.

Further, the plurality of spray holes are uniformly distributed in the circumferential direction of the rolling head.

Further, the spray holes are round holes.

Beneficial effects:

The special internal-cooling rolling tool capable of realizing variable-angle low-temperature lubrication according to the present disclosure can realize low-temperature rolling of the surface of the metal material. With this internal-cooling rolling tool alone, the metal material can be rolled while being cooled and lubricated, thereby simplifying the structure of the rolling device. Besides, the internal-cooling rolling tool is simple to operate and convenient to install, and solves the problems of low working efficiency and low precision in the existing low-temperature rolling device. The tool can realize not only low-temperature rolling of the surface of the metal material, but also rolling at different positions by changing the angle of the rolling head, thereby enhancing the flexibility of rolling strengthening. Also, the positions of the spray holes can be adjusted, thereby prolonging the acting time of the cooling medium and realizing low-temperature rolling of the whole metal. Compared with the existing rolling strengthening device, this internal-cooling rolling tool can introduce high compressive residual stress to the surface of the metal material, thereby improving the fatigue resistance of the workpiece.

### BRIEF DESCRIPTION OF THE DRAWINGS

FIG. 1 is a three-dimensional structural schematic diagram of a special internal-cooling rolling tool capable of realizing variable-angle low-temperature lubrication according to the present disclosure;

FIG. 2 is a structural schematic diagram of the special internal-cooling rolling tool capable of realizing variable-angle low-temperature lubrication in FIG. 1 viewed from A;

FIG. 3 is a sectional view of the special internal-cooling rolling tool capable of realizing variable-angle low-temperature lubrication in FIG. 2 taken along line B-B; and

FIG. 4 is a sectional view of the special internal-cooling rolling tool capable of realizing variable-angle low-temperature lubrication in FIG. 3 taken along line C-C.

Wherein, 1-tool handle, 2-rotatable tool head, 3-medium conveying tube, 11-front end, 12-rear end, 13-central shaft, 21-base, 22-rolling head, 23-ball, 24-medium flow channel, 25-spray hole, 26-internal annular channel.

### DETAILED DESCRIPTION OF THE EMBODIMENTS

The present disclosure will be described in detail in conjunction with the accompanying drawings and examples.

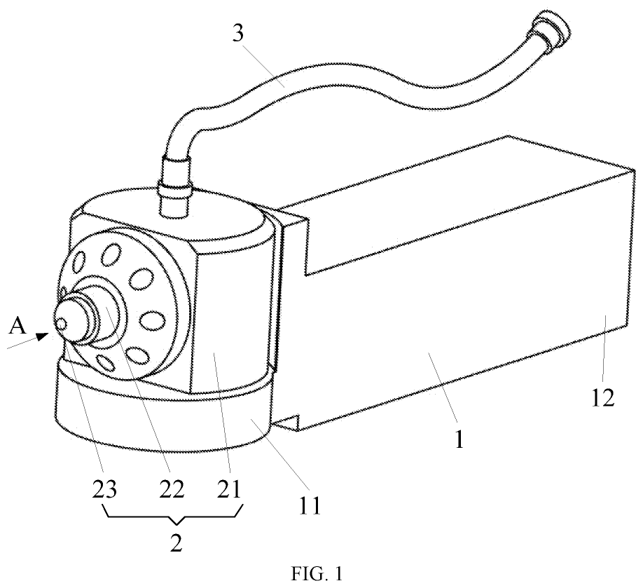

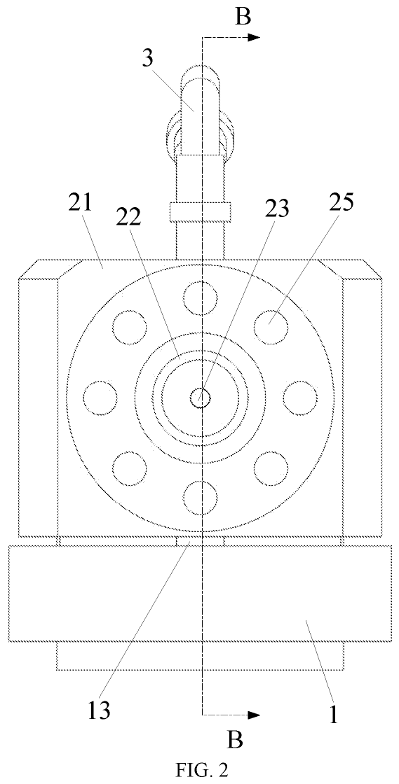

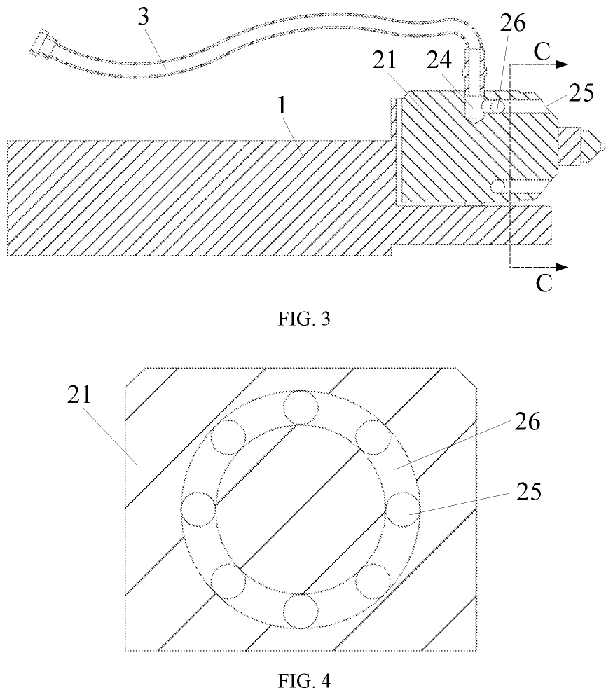

Examples of the present disclosure provide a special internal-cooling rolling tool capable of variable-angle low-temperature lubrication, with reference to FIG. 1, FIG. 2, FIG. 3 and FIG. 4. FIG. 1 shows an overall structural schematic diagram of the special internal-cooling rolling tool capable of variable-angle low-temperature lubrication. FIG. 2 shows a structural schematic diagram of the special internal-cooling rolling tool capable of variable-angle low-temperature lubrication in FIG. 1 viewed from A. FIG. 3 shows a sectional view of the internal-cooling rolling tool in FIG. 2 taken along line B-B. FIG. 4 shows a sectional view of the internal-cooling rolling tool in FIG. 3 taken along line C-C. The internal-cooling rolling tool is used to realize low-temperature rolling of the surface of a metal material, and includes a tool handle 1, a rotatable tool head 2 and a medium conveying tube 3. The tool handle 1 is provided with a front end 11 for assembling the rotatable tool head 2 and a rear end 12 for being fixedly mounted on a tool holder. During use, the rear end 12 of the tool handle 1 is fixedly mounted on the tool holder of a lathe, and the front end 11 of the tool holder is used to mount the rotatable tool head 2.

As shown in the structure of FIG. 1, the rotatable tool head 2 includes a base 21, a rolling head 22 and a ball 23. The bottom end of the base 21 is mounted on the tool handle 1, the front end 11 of the tool handle 1 is provided with a mounting seat for mounting the base 21, and the base 21 is mounted at the top of the mounting seat. The top of the base 21 is provided with a medium input port connected with the medium conveying tube 3, and a medium flow channel 24 is disposed inside the base. The medium conveying tube 3 is used to convey a cooling and lubricating medium. The cooling and lubricating medium may be a low-temperature medium such as liquid nitrogen and supercritical carbon dioxide, or a mixture of a low-temperature medium such as liquid nitrogen and supercritical carbon dioxide and a low-temperature-resistant lubricating oil spray. The flow rate and velocity of the cooling and lubricating medium that is sprayed out may be controlled by controlling the spray velocity of the gas and oil spray, thereby realizing different degrees of cooling. The medium conveying tube 3 may be threadedly connected to the base 21. The rolling head 22 is detachably mounted on the front end surface of the base 21. After the ball 23 is worn to a certain degree, the ball 23 can be replaced conveniently through the detachable rolling head 22. The front end surface of base 21 is provided with a plurality of spray holes 25 for spraying the cooling and lubricating medium in the circumferential direction of the rolling head 22. The spray holes 25 may be round holes. The plurality of spray holes 25 are uniformly distributed in the circumferential direction of the rolling head 22. The specific number of the spray holes 25 may be set according to actual needs. For example, in FIG. 2, there are 8 round spray holes 25 disposed at the front end surface of the base 21.

As shown in structures of FIG. 3 and FIG. 4, the medium conveying tube 3 communicates with the spray holes 25 through the medium flow channel 24, so that the cooling and lubricating medium supplied by the medium conveying tube 3 is sprayed out through the spray holes 25 to quickly cool the surface of the metal material and also lubricate the surface of the metal material to reduce the friction and wear. By controlling the spray angle of the spray holes 25, the acting position and time of the cooling and lubricating medium can be changed, so that the metal material can be cooled in advanced, thereby realizing low-temperature rolling of the whole metal material. The medium flow channel 24 is provided with an internal annular flow channel communicating with all the spray holes 25. Through the internal annular flow channel disposed in the base 21, the cooling and lubricating medium can be conveyed to all the spray holes 25.

The ball 23 is mounted on one end of the rolling head 22 facing away from the base 21. The ball 23 is the main working part of the rolling strengthening. The ball 23 may be a diamond ball or a ceramic ball, so as to process the workpiece of different hardness.

The base 21 has a rotating state and a locked state and is capable of switching between the rotating state and the locked state.

When the base 21 is in the rotating state, the base 21 is capable of rotating in a horizontal plane relative to the tool handle 1 to realize adjustment of the rolling head 22. At this time, when the base 21 rotates relative to the tool handle 1, the angle of the base 21 is adjusted, so that the position of the ball 23 can be adjusted according to the shape of the to-be-processed surface. Suitable angles are selected to realize multi-angle rolling.

When the base 21 is in the locked state, the base 21 is fixed relative to the tool handle 1 so as to perform rolling. After the ball 23 is adjusted in place for rolling, the base 21 is in the locked state such that the base 21 is fixed relative to the tool handle 1, and then the rolling can be performed.

The rotatable tool head 2 of the internal-cooling rolling tool is rotatably mounted on the tool handle 1 through the base 21. The top of the base 21 is connected with the medium conveying tube 3, the base 21 is provided with the plurality of spray holes 25, and the spray holes 25 communicate with the medium conveying tube 3 through the internal medium flow channel 24 inside the base 21, so that the cooling and lubricating medium such as liquid nitrogen or supercritical carbon dioxide can be sprayed onto the surface of the metal material before or during the rolling of the metal material, thereby realizing low-temperature rolling of the surface of the metal material. With this internal-cooling rolling tool alone, the metal material can be rolled while being cooled and lubricated, thereby simplifying the structure of the rolling device. Besides, the internal-cooling rolling tool is simple to operate and convenient to install, and solves the problems of low working efficiency and low precision in the existing low-temperature rolling device. The base 21 is capable of rotating in the horizontal plane relative to the tool handle 1, so the tool can realize not only low-temperature rolling of the surface of the metal material, but also rolling at different positions by changing the angle of the rolling head 22, thereby enhancing the flexibility of rolling strengthening. Also, the positions of the spray holes 25 can be adjusted, thereby prolonging the acting time of the cooling medium and realizing low-temperature rolling of the whole metal. Compared with the existing rolling strengthening device, this internal-cooling rolling tool can introduce high compressive residual stress to the surface of the metal material, thereby improving the fatigue resistance of the workpiece.

There are two methods to fix the base 21 relative to the tool handle 1, i.e., to lock the base 21 to the front end 11 of the tool handle 1.

Method I: The base 21 is provided with a plurality of locking holes distributed in the circumferential direction. The tool handle 1 is provided with one locating pillar protruding toward the tool base 21. When the base 21 is in the rotating state, the locating pillar is disengaged from the locking hole. When the base 21 is in the locked state, the locating pillar is inserted into one of the locking holes, and the locating pillar is used to limit the rotation of the base 21 in the horizontal plane.

Method II: The tool handle 1 is provided with a plurality of locking holes distributed in the circumferential direction. The base 21 is provided with one locating pillar protruding toward the tool handle 1. When the base 21 is in the rotating state, the locating pillar is disengaged from the locking hole. When the base 21 is in the locked state, the locating pillar is inserted into one of the locking holes, and the locating pillar is used to limit the rotation of the base 21 in the horizontal plane.

Through the locating pillar and the locking holes that are matched with each other in the base 21 and the tool handle 1, the base 21 is fixed relative to the tool handle 1, thereby limiting the rotation of the base 21 in the horizontal plane relative to the tool handle 1.

On the basis of the embodiments described above, the base 21 being rotatably mounted on the tool handle 1 may be realized by the following shaft-hole matching structure:

The bottom end of the base 21 is provided with a central hole, the tool handle 1 is provided with a central shaft 13 corresponding to the central hole in position, and the central shaft 13 and the central hole are in clearance fit;

or,

the bottom end of the base 21 is provided with a central shaft 13 protruding toward the tool handle 1, the tool handle 1 is provided with a central hole corresponding to the central shaft 13 in position, and the central shaft 13 and the central hole are in clearance fit.

Through the central shaft 13 and the central hole that are matched with each other in the base 21 and the tool handle 1, the freedom of movement of the base 21 in the horizontal plane can be limited, so that the base 21 can only rotate relative to the tool handle 1. Through the matching between the central hole and the central shaft 13 in combination with the locking structure of the locating pillar and the locking hole, the base 21 can be detached from or mounted to the tool handle 1 conveniently and quickly. Moreover, the structure is simple.

In conclusion, the above embodiments are only preferred embodiments of the present disclosure, and are not intended to limit the protection scope of the present disclosure. Any modification, equivalent replacement, or improvement made within the spirit and principle of the present disclosure shall fall into the protection scope of the present disclosure.

1. An internal-cooling rolling tool capable of realizing variable-angle low-temperature lubrication, comprising:
a tool handle, a rotatable tool head and a medium conveying tube;
wherein:
the tool handle is provided with a front end for assembling the rotatable tool head and a rear end for being fixedly mounted on a tool holder;
the rotatable tool head comprises a base, a rolling head and a ball; a bottom end of the base is mounted on the tool handle, a top of the base is provided with a medium input port connected with the medium conveying tube, and a medium flow channel is disposed inside the base; the rolling head is detachably mounted on a front end surface of the base, and the front end surface of the base is provided with a plurality of spray holes for spraying a cooling and lubricating medium in a circumferential direction of the rolling head; the ball is mounted on one end of the rolling head facing away from the base;
the medium conveying tube communicates with the spray holes through the medium flow channel; the medium conveying tube is configured to convey the cooling and lubricating medium; and
the base has a rotating state and a locked state and is capable of switching between the rotating state and the locked state, wherein when the base is in the rotating state, the base is capable of rotating in a horizontal plane relative to the tool handle so as to realize adjustment of the rolling head; and when the base is in the locked state, the base is fixed relative to the tool handle so as to perform rolling.

2. The internal-cooling rolling tool according to claim 1, wherein the medium flow channel is provided with an internal annular flow channel communicating with all the spray holes.

3. The internal-cooling rolling tool according to claim 1, wherein the base is provided with a plurality of locking holes distributed in a circumferential direction;
the tool handle is provided with one locating pillar protruding toward the base;
when the base is in the rotating state, the locating pillar is disengaged from the locking hole; and
when the base is in the locked state, the locating pillar is inserted into one of the locking holes, and the locating pillar is configured to limit the rotation of the base in the horizontal plane.

4. The internal-cooling rolling tool according to claim 1, wherein the tool handle is provided with a plurality of locking holes distributed in a circumferential direction;
the base is provided with one locating pillar protruding toward the tool handle;
when the base is in the rotating state, the locating pillar is disengaged from the locking hole; and
when the base is in the locked state, the locating pillar is inserted into one of the locking holes, and the locating pillar is configured to limit the rotation of the base in the horizontal plane.

5. The internal-cooling rolling tool according to claim 1, wherein the bottom end of the base is provided with a central hole;
the tool handle is provided with a central shaft corresponding to the central hole in position; and
the central shaft and the central hole are in clearance fit.

6. The internal-cooling rolling tool according to claim 1, wherein the bottom end of the base is provided with a central shaft protruding toward the tool handle;
the tool handle is provided with a central hole corresponding to the central shaft in position; and
the central shaft and the central hole are in clearance fit.

7. The internal-cooling rolling tool according to claim 1, wherein the ball is a diamond ball or a ceramic ball.

8. The internal-cooling rolling tool according to claim 1, wherein the medium conveying tube is threadedly connected to the base.

9. The internal-cooling rolling tool according to claim 1, wherein the plurality of spray holes are uniformly distributed in the circumferential direction of the rolling head.

10. The internal-cooling rolling tool according to claim 1, wherein the spray holes are round holes.
